(19) United States
(12) Patent Application Publication
(10) Pub. No.: US 2015/0241004 A1
(43) Pub. Date: Aug. 27, 2015

(54) Lighting Device

(71) Applicants: Raimund Oberschmid, Sinzing (DE); Martin Moeck, Erlangen (DE)

(72) Inventors: Raimund Oberschmid, Sinzing (DE); Martin Moeck, Erlangen (DE)

(73) Assignee: OSRAM GMBH, Muenchen (DE)

(21) Appl. No.: 14/343,739

(22) PCT Filed: Aug. 10, 2012
(86) PCT No.: PCT/EP2012/065760

§ 371 Date: Apr. 13, 2015

(30) Foreign Application Priority Data
Sep. 7, 2011 (DE) 10 2011 112 710.4

(51) Int. Cl. F21K 99/00

(52) U.S. Cl. CPC F21K 9/50; F21K 9/56

(57) ABSTRACT

A lighting device has a carrier plate having a reflective assembly surface on which a plurality of light emitting semiconductor chips spaced apart from each other is arranged. A translucent or transparent emission plate is arranged downstream of the light emitting semiconductor chips in the emission direction and has a light decoupling surface facing away from the light emitting semiconductor chips. The emission plate has a plurality of recesses which are each arranged after at least one semiconductor chip. Each of the recesses has a diffusor material and/or a wavelength conversion material on the inner surface facing the semiconductor chips, and spaced apart from the light emitting semiconductor chips.

This patent application is a national phase filing under section 371 of PCT/EP2012/065760, filed Aug. 10, 2012, which claims the priority of German patent application 10 2011 112 710.4, filed Sep. 7, 2011, each of which is incorporated herein by reference in its entirety.

### TECHNICAL FIELD

A lighting device, for example for room lighting, is specified.

A high light intensity is required for room lighting. A high level of waste heat can also arise upon the use of light-emitting diodes (LED) as light sources. Known LED-based light sources are therefore typically constructed with special consideration of the chip materials and the heat dissipation materials and often have active cooling, which cools a cooling body with the aid of a fan air flow.

To generate mixed-color light and in particular white light, LED-based light sources typically have light-emitting diode chips, which are individually provided with a luminescent substance. In order that a uniform color impression can result with a light source having a plurality of such LED-based light sources having individual luminescent substances, the respective emitted color must be set very precisely beforehand by a precise selection of the light-emitting diode chips and the luminescent substance layers. High demands result therefrom on precise color measuring technology and precise manufacturing control of the light-emitting diode chips.

In addition, typical ballasts for LED-based light sources are usually embodied as potential-free compact switched-mode power supplies, which typically can have significant power losses of up to 20%.

### SUMMARY OF THE INVENTION

Embodiments of the invention specify a lighting device, which has a plurality of light-emitting semiconductor chips.

According to at least one embodiment, a lighting device has a carrier plate, on which a plurality of light-emitting semiconductor chips spaced apart from one another is arranged. In particular, the lighting device can be suitable for room lighting.

According to a further embodiment, the carrier plate has a plastic material and can have in particular a plastic plate or plastic layer, for example. Furthermore, the carrier plate can have conductor paths or electrical contact paths on a surface or in the interior, by means of which the light-emitting semiconductor chips can be electrically contacted. In addition, the carrier plate can have, for example, a metal layer and/or a metal plate. For example, the carrier plate can have a plastic layer, which is glued to a metal plate or a metal foil. The metal plate or metal foil can be arranged on the rear side of the carrier plate, facing away from the semiconductor chip, for example.

According to a further embodiment, the carrier plate has a reflective mounting surface, on which the plurality of light-emitting semiconductor chips is arranged. The reflective mounting surface can be formed in particular by a metallically conductive layer, i.e., for example, by an applied layer having a reflective metal. The metallically conductive layer can also offer an electrical terminal for the semiconductor chips, for example, and can be at least partially implemented in the form of conductor paths, contact paths, and/or terminal surfaces. The metallically conductive layer can be vapor deposited or structured by photographic technology, for example, and subsequently electrolytically reinforced. It is also possible to print on the metallically conductive layer by other methods and subsequently generate the desired structure thermally and/or chemically. Alternatively thereto, it is also possible to apply a stamped-out metal foil in a planar manner by sticking it on. In particular, the metallically conductive layer can be applied to a plastic film or plastic plate.

According to a further embodiment, the semiconductor chips are applied to the metallically conductive layer by gluing, for example, by means of a conductive adhesive, or by soldering. It is also possible to electrically connect light-emitting semiconductor chips to the metallically conductive layer using contact terminals facing away from the carrier by bonding, i.e., by so-called bond wires.

According to a further embodiment, the light-emitting semiconductor chip has a translucent or transparent, i.e., a diffusely sheer or clear emission plate having a light outcoupling surface facing away from the light-emitting semiconductor chips, arranged downstream in the emission direction. The emission plate can have a transparent or translucent material or can be made thereof, for example, a plastic material or a glass.

The emission plate can be implemented as a scattering disc, for example, which has an antiglare light outcoupling surface in conjunction with the reflective mounting surface of the carrier plate in particular.

According to a further embodiment, the emission plate has a recess over each of the plurality of the light-emitting semiconductor chips, wherein each of the recesses has a diffuser material and/or a wavelength conversion material on an inner surface facing toward the semiconductor chips. The recesses have dimensions such that the diffuser material or the wavelength conversion material is spaced apart from the semiconductor chips.

According to a further embodiment, the recesses are implemented in the form of spherical caps. In particular, the recesses can be implemented in the form of spherical sections or ellipsoid sections, so that the respective inner surface has the form of a spherical shell or an ellipsoid shell. The recesses can be incorporated in the emission plate by embossing, for example. It is also possible to produce the recesses simultaneously during the production of the emission plate. If the emission plate has a plastic or a glass or is made thereof, the recesses can be incorporated during the shaping of the emission plate, for example, by casting. It is also possible to incorporate the recesses in a rolling method.

According to a further embodiment, the recesses are implemented identically, i.e., in particular having identical shape and identical size. Alternatively, it is also possible that the recesses are implemented differently.

According to a further embodiment, respectively precisely one light-emitting semiconductor chip is arranged in each recess. Furthermore, precisely one recess can be arranged downstream from each of the semiconductor chips.

According to a further embodiment, the recesses have a diameter which is at least two times greater than side lengths of the light-emitting semiconductor chips. Furthermore, the recesses can have diameters which are less than or equal to twenty times the side lengths of the light-emitting semiconductor chips. Adjacent recesses can preferably be spaced apart from one another. Alternatively thereto, it is also possible that adjacent recesses merge into one another.

According to a further embodiment, the emission plate is fixed on the carrier plate. For example, the emission plate can be fastened on the carrier plate by means of a fixed but detachable connection capability. For example, the emission plate can be connected to the carrier plate by means of clamping nails. The clamping nails, which can be implemented as plastic nails or plastic rivets, for example, can extend from the light emission surface of the emission plate through the emission plate and the carrier plate up to a rear side of the carrier plate, where they are connected to clamping nail caps in a clamped connection. The emission plate and the carrier plate can have holes for this purpose, through which the clamping nails protrude. Alternatively to the clamping nails, other connecting pins can also be used, for example, screws. Furthermore, the emission plate can also be fastened so it is laterally displaceable on the carrier plate, for example, using connecting pins such as clamping nails or eccentric screws and boreholes or holes in the carrier plate and/or the emission plate, which have a larger diameter than the connecting pins or which are embodied as oblong holes, for example. In addition, other known fastening and alignment possibilities and alignment setting aids can also be provided, by means of which two large plates can be aligned and fixed precisely fitted with one another so that they are laterally displaceable.

According to a further embodiment, the light-emitting semiconductor chips are capable of emitting light in a wavelength range from ultraviolet radiation up to infrared radiation, particularly preferably of visible light. One or more or all of the semiconductor chips can emit monochromatic light or also mixed-color light, for example, white light. A semiconductor chip can have a light-emitting semiconductor layer sequence for this purpose, which directly emits monochromatic light or on which, in addition, a wavelength conversion element in the form of a luminescent substance layer, a luminescent substance plate, or a grouting containing luminescent substance is applied, which can convert at least a part of the radiation generated by the semiconductor layer sequence into light having another wavelength. The semiconductor chips can be implemented in particular as epitaxially grown semiconductor layer sequences or can each have an epitaxially grown semiconductor layer sequence. The semiconductor layer sequence can have an arsenide, phosphide, and/or nitride compound semiconductor material, which is implemented in accordance with the desired light with respect to its composition and with respect to its layer structure. In particular, one or more or all semiconductor chips can be installed directly on the carrier body, i.e., in particular on the reflective mounting surface, without a respective housing body.

According to a further embodiment, the semiconductor chips are identical to one another and emit at least substantially identical light. “Substantially identical light” and “identical semiconductor chips” means here and hereafter that the light emitted by the individual semiconductor chips and also the compositions of the semiconductor chips can differ in the scope of routine production variations, for example. In particular, the semiconductor chips can preferably emit blue light. The light of the semiconductor chips can be partially converted into different-colored light by means of the wavelength conversion material, as explained hereafter, so that the lighting device can emit mixed-color light.

According to a further embodiment, multicolored emitting semiconductor chips are used, which first allow a desired mixed-color lighting, in particular white lighting at the lighted location. The light emission plate can thus have multicolored light spots, while the lighting effect is generated by the superposition and the mixing of the individual different colors of the semiconductor chips. It can thus also be possible that, for example, items of information, for example, traffic-engineering items of information, notification texts, or logos such as company logos are written so they are clearly readable in color on the light emission surface, while white light is perceived at a location to be lighted, for example, due to the arrangement of multicolored semiconductor chips. Such a non-commonplace experience is heretofore only known from ground glass prisms of chandeliers, for example, in which colored regions of the lamp are artificially produced from white light.

According to a further embodiment, the semiconductor chips are arranged spaced apart from one another on the carrier plate in such a manner that the spacing of each two semiconductor chips directly adjacent to one another is a multiple of the side lengths of the semiconductor chips. Typical side lengths for semiconductor chips can be less than or equal to several millimeters, for example, in particular less than or equal to 1 mm.

According to a further embodiment, the semiconductor chips are distributed having a density of approximately 1 semiconductor chip per square centimeter on the carrier plate.

The spaced-apart arrangement of the semiconductor chips on the carrier plate allows a large emission surface with lower power loss allocation at the same time, i.e., the power loss heat arising in operation of the light-emitting semiconductor chips is uniformly distributed in the carrier body and thus no so-called “hot spots” result.

In particular, the lighting device can have a large light emission surface in conjunction with a small power loss allocation due to the light-emitting semiconductor chips spaced apart from one another, whereby effective heat transfer is possible from the semiconductor chips to the surrounding air in a simple manner, via the carrier plate and via the light outcoupling surface of the emission plate. In particular, it can be advantageous if the metallically conductive layer has a significantly larger surface than the surface occupied by the semiconductor chips, whereby effective heat distribution on the carrier plate is achieved. Simultaneously, as described above, the semiconductor chips can be glued or soldered in an electrically conductive manner on the metallically conductive layer, so that the metallically conductive layer also has contact terminals and can be used for current supply. If the carrier plate has an insulating layer, for example, a plastic layer, to which the metallically conductive layer is applied, and if the insulating layer has a sufficiently high level of electrical insulation from contact possibilities, the entire interconnection of the light-emitting semiconductor chips can thus also be performed at power network potential, for example. Simple low-loss power supply units having voltages of multiple times the respective individual voltage of a semiconductor chip can be used. An exemplary embodiment of a suitable electrical circuit is described hereafter.

The heat flow from the individual semiconductor chips, which is broadened by the metallically conductive layer, must flow up to the rear side of the carrier plate through the insulating layer, however, the heat resistance thereof is typically significantly lower in relation to the transition between the carrier plate and the air. The maximum density of the semiconductor chips on the carrier plate, in particular on the metallically conductive layer, is substantially determined by the physically limited air-heat transfer coefficient in the case of natural convection of at most approximately 10 W/(K·m²), wherein the natural convection can also be supplemented by heat emission of at most the same order of magnitude.

According to a further embodiment, the carrier plate has a plurality of webs on the mounting surface and/or a rear side opposite to the mounting surface. The webs can be implemented in the form of profile nubs or web-shaped protrusions, for example. An increase of the stability of the carrier plate can be achieved by the webs, for example. For example, the carrier plate can have a thickness of approximately 0.5 mm to approximately 2 mm between the webs, while the webs can have a web height in the order of magnitude of 0.3 mm to 2 mm, wherein the boundaries are respectively enclosed, whereby mechanical strength and therefore security against bending and twisting can be given to the material of the carrier plate. Bending or twisting of the carrier plate is to be avoided, since this can result in solder cracks or adhesive cracks of the semiconductor chips on the mounting surface.

The emission plate can have grooves on the side facing toward the carrier plate, in which webs provided on the installation side of the carrier plate are arranged. An increase of the stability of the connection between the carrier plate and the emission plate can thus also be achieved.

Furthermore, in particular webs which are arranged on the rear side opposite to the mounting surface can also be used for cooling, for example. It is particularly advantageous for the cooling if the webs, which are arranged on the rear side, extend such that they are parallel to the main cooling air flow, i.e., in the case of natural convection perpendicularly to the later operating alignment of the lighting device. In other words, the rear-side webs can particularly preferably extend along the direction of gravity in the case of a lighting device arranged for operation.

Therefore, mechanical stiffening and at the same time a surface enlargement to improve the heat transfer to air flowing past, i.e., convection, and also to improve the heat emission can be achieved by the webs, in particular rear-side webs, for example, in the form of profile nubs in the perpendicular air flow direction to achieve a chimney effect.

According to a further embodiment, the emission plate has a web-shaped structure on the light outcoupling surface. Using this, a similar effect can be achieved as by the webs of the carrier plate. Furthermore, the emission characteristic of the lighting device can also be influenced by the web-shaped structure on the light outcoupling surface.

According to a further embodiment, the carrier plate, or at least the rear side of the carrier plate facing away from the mounting surface, has a material or a coating which has good heat emission. In particular, good heat emission is understood as a degree of heat emission which is as close as possible to 1 in a temperature range from approximately 50° C. to approximately 100° C. Such a degree of heat emission can be achieved, for example, by means of glass as the material of the carrier plate. In the case of a rear-side coating of the carrier plate, the coating can be rough in particular, for example, formed by a radiator paint or a suitable lacquer or a glazing.

According to a further embodiment, the rear side, which is opposite to the mounting surface, of the carrier plate is formed by a metal plate or metal foil. The metal plate or metal foil can have the above-described webs and/or an above-described heat-emitting surface coating, for example. In the case of a metal plate or metal foil forming the rear side of the carrier plate, the heat-emitting surface coating can also be implemented as an anodized layer, for example. Furthermore, it is also possible to provide the rear-side metal plate or metal foil for connecting a protective ground conductor for the lighting device.

According to a further embodiment, a wavelength conversion material is arranged downstream in each case from the light-emitting semiconductor chips. As described above, the wavelength conversion material can be arranged in the form of a luminescent substance directly on the semiconductor chips. The wavelength conversion material is particularly preferably arranged in the recesses of the emission plate, however. It is also possible that a wavelength conversion material is implemented in each case both directly on a semiconductor chip and also on the inner surface of the recess arranged downstream from the semiconductor chip, wherein the wavelength conversion materials can be identical or different, to achieve a desired emission characteristic.

According to a further embodiment, the respective wavelength conversion material in the recesses is capable of converting the primary light emitted from the respective associated light-emitting semiconductor chips into a secondary light different therefrom. The primary light and the secondary light can comprise one or more wavelengths and/or wavelength ranges in an infrared to ultraviolet wavelength range, in particular in a visible wavelength range. For example, the primary light can have a wavelength range from an ultraviolet to green wavelength range, while the secondary light can have a wavelength range from a blue to infrared wavelength range. The primary light and the secondary light can particularly preferably arouse a white-colored light impression when superimposed. For this purpose, the primary light can preferably arouse a blue-colored light impression and the secondary light can arouse a yellow-colored light impression, which can arise due to spectral components of the secondary radiation in the yellow wavelength range and/or spectral components in the green and red wavelength range.

The wavelength conversion material can have one or more of the following materials: garnets of the rare earth metals and the alkaline earth metals, for example, YAG:Ce³⁺, nitrides, nitridosilicates, sions, sialons, aluminates, oxides, halophosphates, orthosilicates, sulfides, vanadates, and chlorosilicates. Furthermore, the wavelength conversion material can additionally or alternatively comprise an organic material, which can be selected from a group which comprises perylenes, benzopyrenes, coumarins, rhodamines, and azo dyes. The wavelength conversion material in the recesses can respectively have suitable mixtures and/or combinations of the mentioned materials.

The material or materials for the wavelength conversion material can be implemented in the form of particles, which can have a size from 2 μm to 10 μm.

According to a further embodiment, a diffuser material is arranged on the inner surfaces of the recess, which can have, in particular, scattering particles or can be formed thereof which scattering particles can have, for example, a metal oxide, thus, for example, titanium oxide or aluminum oxide, such as corundum, and/or glass particles or can be made thereof. The scattering particles can have diameters or grain sizes of less than 1 μm up to an order of magnitude of 10 μm or also of up to 100 μm.

Furthermore, the diffuser material and/or the wavelength conversion material can be embedded in a transparent matrix material and/or chemically bonded thereon. The transparent matrix material can comprise, for example, siloxanes, epoxides, acrylates, methyl methacrylates, imides, carbonates, olefins, styrenes, urethanes, or derivatives thereof in the form of monomers, oligomers, or polymers and furthermore also mixtures, copolymers, or compounds therewith. For example, the matrix material can comprise or be made of an epoxide resin, polymethyl methacrylate (PMMA), polystyrene, polycarbonate, polyacrylate, polyurethane, or a silicone resin, for example, polysiloxane, or mixtures thereof.

The respective diffuser material and/or the respective wavelength conversion material in the recesses can be homogeneously distributed in the matrix material. Furthermore, in one or more or all recesses, a combination of multiple of the mentioned materials for the diffuser material and/or the wavelength conversion material can respectively be arranged, which can be mixed or can be provided in various layers.

According to a further embodiment, the diffuser material and/or the wavelength conversion material are implemented in layered form on the inner surface. The diffuser material and/or the wavelength conversion material can thus be arranged in particular spaced apart from the respective assigned light-emitting semiconductor chips in the recess. The diffuser material and/or the wavelength conversion material can be distributed uniformly over the inner surface of a recess. Alternatively thereto, it is also possible, for example, that a wavelength conversion material is applied unevenly with respect to its composition and/or with respect to its thickness in a recess by a sedimentation method or another suitable method in order, for example, to achieve a desired color light density effect and color emission effect.

According to a further embodiment, the emission plate has a wavelength conversion material in at least some or also all recesses on the inner surface facing toward the semiconductor chips, this wavelength conversion material having a reflector layer on the respective side facing toward the semiconductor chips, which is reflective for the secondary light converted by the wavelength conversion material and is transparent for the primary light emitted by the semiconductor chips. The reflector layer can be applied in the form of a so-called Bragg reflector in the multilayer method, for example.

In the case of a wavelength conversion material, which is arranged spaced apart from a semiconductor chip, on the inner surface of a recess, the wavelength conversion material can be thermally separated from the semiconductor chips. The so-called Stokes conversion waste heat arising in the wavelength conversion material, which arises during the conversion of the primary light of the semiconductor chip into the secondary light, can thus be prevented from heating the semiconductor chip. The conversion waste heat can rather be emitted via the emission plate to the surrounding air at the light outcoupling surface, whereby the wavelength conversion material and also the semiconductor chip can be kept cooler than in the case of a wavelength conversion material arranged directly on a semiconductor chip. Furthermore, the wavelength conversion material on the inner surface of the recess above the semiconductor chip offers a larger converter layer surface in relation to a direct chip coating, whereby the power density of the primary light in the wavelength conversion material becomes less. A significantly lesser degree of aging degradation of the wavelength conversion material is thus to be expected.

Furthermore, by way of the diffuser material and/or the wavelength conversion material on the inner surface of the recesses, the dazzling effect due to the light-emitting semiconductor chips can be sufficiently small, when looking directly at the light outcoupling surface without additional scattering measures, that no unpleasant consequences result in the case of an observer.

According to a further embodiment, the carrier plate is equipped with the light-emitting semiconductor chips. For example, the semiconductor chips can all emit identical light, in particular blue light, in operation. Manufacturing tolerances with respect to the individual semiconductor chips, which result in slightly different colorimetric loci and/or wavelength ranges of the respective emitted light, can be established by means of brief operation of the semiconductor chips and a spectral measurement, which is preferably rapid. The respective compositions and thicknesses of the wavelength conversion materials and also the respective distributions thereof on the inner surfaces of the recesses of the emission plate which are necessary so that the most uniformly bright and identically colored light, for example, white light can be emitted over the entire emission plate can be calculated therefrom. For example, in the case of slightly different blue wavelengths emitted from the semiconductor chips, corresponding different materials and/or compositions of the wavelength conversion materials and/or various thicknesses of the wavelength conversion materials can be calculated. In particular, for example, automatically running, individually controlled coating processes for the wavelength conversion materials in the recesses of the emission plate can be regulated by the data of the spectral measurements in such a manner that the color variations of the semiconductor chips can be equalized by adapted wavelength conversion materials.

It is thus possible to select and install semiconductor chips from a larger color and brightness tolerance range, since complex individual color compensation does not have to be performed chip for chip. Rather, a spectral measurement of all, for example, more than one hundred, light-emitting semiconductor chips on the carrier is sufficient, which can be followed by an individual coating of the recesses of the emission plate in an automatic process, after which the emission plate is then assembled with the carrier.

According to a further embodiment, the emission plate has scattering particles distributed in the emission plate for diffuse scattering. The scattering particles, which can also be melted in during the production of the emission plate, for example, can comprise an above-described diffuser material, for example. Furthermore, it is also possible that the emission plate has a sheer, light-scattering coating on the light outcoupling surface. The scattering body and/or the coating particularly advantageously have the highest possible degree of absorption or the highest possible degree of scattering, respectively, in the temperature range from 30° C. to 80° C.

Furthermore, it is also possible that the emission plate has scattering structures, for example, in the form of depressions or protrusions, on the light outcoupling surface, which can be distributed uniformly or randomly on the light outcoupling surface. Additionally or alternatively, it is also possible that the emission plate has a scattering coating or scattering structures on the side opposite to the light outcoupling surface and facing the carrier plate.

According to a particularly preferred embodiment, the lighting device particularly preferably has light-emitting semiconductor chips, which are spatially separated from one another, i.e., spaced apart from one another, on the mounting surface, from which the emission plate having the recesses is arranged downstream, wherein a wavelength conversion material is arranged in the recesses. In comparison to conventionally used costly aluminum or copper carriers or corresponding metal-core printed circuit boards, good heat dissipation can preferably be formed by a metallically conductive layer on a plastic layer or plastic plate, to which the semiconductor chips are electrically connected and simultaneously also thermally connected. By way of the arrangement of the semiconductor chips on the carrier plate and the emission plate arranged downstream from the semiconductor chips, the individual semiconductor chips can meet the requirements which are delimited with respect to the size and power thereof and also with respect to the respective emitted colorimetric locus thereof. The emission plate preferably has, in addition to the wavelength conversion material in the recesses, scattering structures on the light emission surface and/or the surface opposite to the light emission surface and/or in the form of scattering particles embedded in the volume. In addition, the combination with the above-described webs, in particular on the rear side of the carrier plate, is particularly advantageous to achieve simple and nonetheless sufficient cooling action with mechanical strength and stiffening at the same time.

According to a further embodiment, the emission plate has a lens-shaped surface structure over at least some recesses. The surface structure can be implemented in particular as a bulge, i.e., convexly, on the light outcoupling surface. It is also possible that the lens-shaped surface structure protrudes in the form of an indentation, i.e., concavely, as a depression into the light outcoupling surface. By way of the lens-shaped surface structures, it can be possible to optimize the emission behavior as desired in particular for the far field of the lighting device. A lens-shaped surface structure does not have to be provided over all recesses and therefore over all light-emitting semiconductor chips. However, it can also be possible that a lens-shaped surface structure is arranged over each of the recesses, so that precisely one bulge or indentation is provided per recess. The lens-shaped surface structures can also be incorporated simultaneously as described above for the recesses during the production of the emission plate, for example, by an embossing or rolling method or by a casting process, by which the emission plate is produced, for example, from a plastic material or glass. It is also possible to apply the lens-shaped surface structures later to the light outcoupling surface of the emission plate in a rolling method, in particular in the case of convex bulges made of a clear or sheer material. The material of the lens-shaped surface structures can be the same material as that for the emission plate or also a different material.

According to a further embodiment, the lighting device has an electrical circuit for operating the semiconductor chips of the lighting device. The electrical circuit which can allow the operation of the lighting device using network voltage, for example, can have, for example, a ballast, which is not network-potential-free, having bridge rectifier, current-limiting series capacitor, and a small series resistor, which limits the activation current, in an electrical supply line of the lighting device. The carrier plate having the semiconductor chips and the emission plate can thus be implemented to be particularly filigree. Alternatively thereto, it is also possible to integrate parts of the electrical circuit, for example, the ballast, in the lighting device.

The lighting device described here can be dazzle-free according to the features and embodiments set forth, for example. Furthermore, the heat can be dissipated directly to the surroundings, i.e., the room air, for example, without additional fans and the resultant noise associated therewith having to be accepted. Furthermore, the mechanical installation can be performed easily, wherein the electrical contacting and the heat dissipation and also the high-voltage insulation, for example, up to 4 kV, can be made possible at the same time.

### BRIEF DESCRIPTION OF THE DRAWINGS

Further advantages, advantageous embodiments, and refinements result from the exemplary embodiments described hereafter in conjunction with the figures.

FIG. 1 shows a schematic view of a lighting device according to one exemplary embodiment;

FIGS. 2A to 7C show schematic views of lighting devices according to further exemplary embodiments;

FIG. 8 shows schematic views of arrangements of lighting devices in a room according to further exemplary embodiments; and

FIG. 9 shows a schematic view of an electrical circuit for operating a lighting device according to a further exemplary embodiment.

Identical, similar, or identically acting elements can each be provided with the same reference signs in the exemplary embodiments and figures. The illustrated elements and the size relationships to one another thereof are not to be considered to be to scale, rather, individual elements, for example, layers, parts, components, and regions, can be shown exaggeratedly large for better illustration ability and/or for better understanding.

### DETAILED DESCRIPTION OF ILLUSTRATIVE EMBODIMENTS

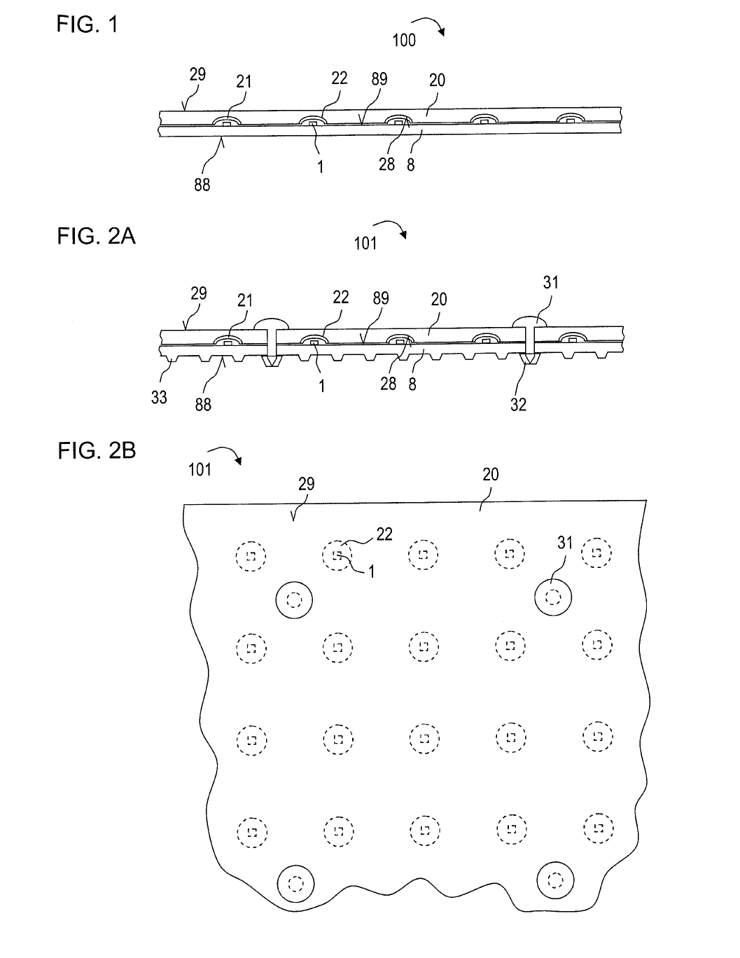

FIG. 1 shows a detail of a lighting device 100 according to a first exemplary embodiment. The lighting device 100 has a plurality of light-emitting semiconductor chips 1, which are arranged on a carrier plate 8. The carrier plate has, in the exemplary embodiment shown, a plastic plate or plastic layer, on which a metallically conductive layer is arranged as a reflective mounting surface 89, which can also be used for the electrical connection of the semiconductor chips 1, in addition to the reflection of the primary light emitted from the light-emitting semiconductor chips 1.

A translucent or transparent emission plate 20, which has a light outcoupling surface 29, which faces away from the semiconductor chips 1 and via which the light emitted from the semiconductor chips 1 can be emitted from the lighting device 100, is arranged downstream from the light-emitting semiconductor chips 1 in the emission direction. The emission plate 20 has recesses 22 above the light-emitting semiconductor chips 1, wherein each of the recesses 22 has an inner surface 28, on which a wavelength conversion material 21 is arranged. Alternatively or additionally to the wavelength conversion material 21, a diffuser material can also be arranged on the inner surfaces 28 of the recesses 22.

The semiconductor chips 1 can emit blue light, for example, which is partially converted into yellow and/or green and red secondary light by the wavelength conversion material 21, so that the lighting device 100 emits white light in operation.

The light-emitting semiconductor chips 1 all emit identical light in the exemplary embodiment shown. This can mean in particular that the semiconductor chips 1 emit blue light, which is not exactly identical in the scope of manufacturing variations, but rather can be different from semiconductor chip to semiconductor chip. To achieve a homogeneous light distribution over the light outcoupling surface 29, the semiconductor chips 1 can be spectrally measured successively after the installation of the reflective mounting surface 89 of the carrier plate 8. According to the respective colorimetric locus of the semiconductor chips 1, the wavelength conversion material 21 in each assigned recess 22 can be adapted accordingly with respect to its composition and/or its thickness, to achieve the greatest possible homogeneity over the light emission surface 29 with respect to both the emitted brightness and also the emitted colorimetric locus.

In the exemplary embodiment shown, one recess 22 is arranged downstream from precisely one semiconductor chip 1 in each case. Alternatively thereto, it is also possible that multiple semiconductor chips 1 are arranged inside a recess 22. The semiconductor chips 1 are distributed as relatively small units in a large area on the mounting surface 89 of the carrier 8. The carrier 8 particularly preferably has approximately one semiconductor chip 1 per square centimeter. A large radiator surface and a small power loss allocation can thus be achieved.

The emission plate 20 is made of a plastic material or a glass, which can be transparent, i.e., clear, or translucent, i.e., diffusely sheer. A sheer effect can be achieved, for example, by scattering bodies inside the emission plate 20 or by scattering surface structures or coatings on the light emission surface 29 or the side of the emission plate 20 opposite to the light emission surface 29.

The lighting device 100 can be embodied in any arbitrary size and can have more than 100 light-emitting semiconductor chips 1, for example. A suitable electrical circuit for operating the lighting device 100 is shown in conjunction with FIG. 9.

The exemplary embodiments shown in the following figures for lighting devices represent modifications and refinements of the lighting device 100 shown in FIG. 1.

The lighting device 101 according to the exemplary embodiment in FIGS. 2A and 2B, which respectively show a section of a schematic sectional view and a top view of the light outcoupling surface 29 of the lighting device 101, has, in addition to the lighting device 100 of the exemplary embodiment in FIG. 1, a plurality of webs 33 on the rear side 88 of the carrier plate 8 facing away from the semiconductor chip 1. These webs are used, on the one hand, for stiffening the carrier plate 8 and therefore the entire lighting device 101, but are also suitable for enlarging the surface area of the rear side 88 of the carrier plate 8, to achieve better heat transfer between the carrier plate 8 and the surrounding air. For example, the webs 33 can be embodied in the form of profile nubs, which are preferably arranged, with respect to the arrangement of the lighting device 101 during operation, along the air flow direction to achieve a chimney effect. An improvement of the heat dissipation to the air flowing past can be achieved by the convection thus achieved.

In the exemplary embodiment shown, the carrier plate 8 and the emission plate 20 are connected to one another by means of clamping nails 31. These are implemented as plastic nails, protrude through the emission plate 20 and the carrier plate 8, and are clamped with clamping nail caps 32 arranged on the rear side 88 of the carrier plate 8. The emission plate 20 and the carrier plate 8 can be stapled together fixedly but also detachably by the clamping nails 31, which can also be embodied as plastic rivets, and the clamping nail caps 32, which can also be referred to as counter clamping caps.

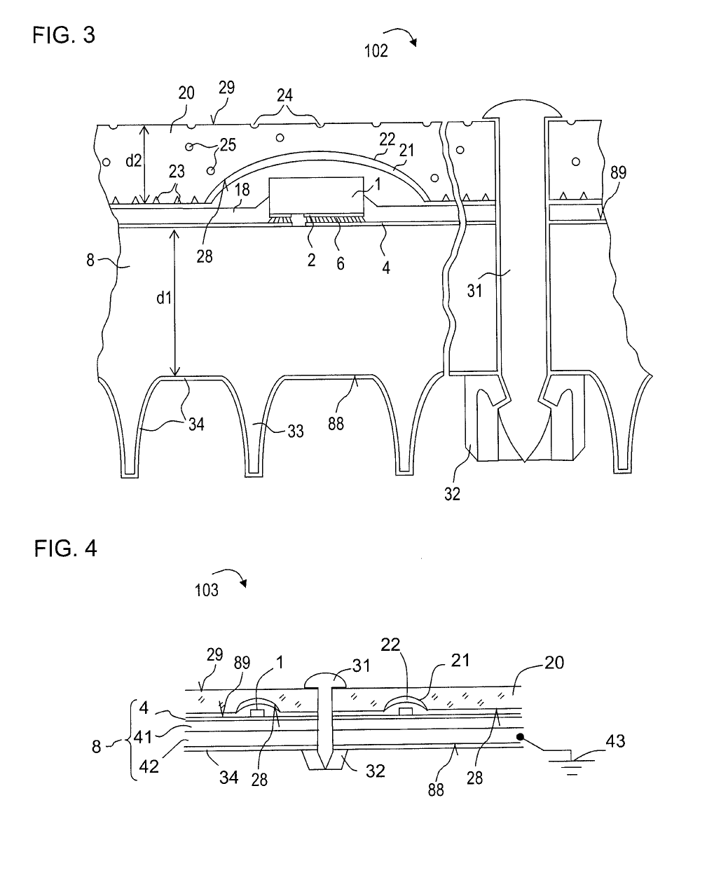

FIG. 3 shows a further exemplary embodiment of a lighting device 102. It has semiconductor chips 1 implemented as so-called flip chips, which are arranged on a metallically conductive layer 4 of the carrier 8 and are connected thereto in an electrically conductive manner. For this purpose, a connecting layer 6, for example, in the form of a conductive adhesive or a solder layer, is arranged between rear-side chip metal contact layers 2 of the semiconductor chips 1 and terminal regions of the metallically conductive layer 4. Furthermore, the semiconductor chips 1 are grouted by means of a transparent grouting 18 on the metallically conductive layer 4, so that a contact protection in relation to the metallically conductive layer 4 can be achieved by the grouting 18.

Furthermore, the carrier 8 has a plastic plate, on which the metallically conductive layer 4 is applied, and the rear side 88 of which has webs 33. The plastic plate of the carrier plate 8 has, in the exemplary embodiment shown, a thickness d1 of approximately 0.5 mm to approximately 2 mm, while the emission plate 20 arranged above it has a thickness d2 of approximately 1 mm to approximately 2 mm, wherein the boundaries are respectively included. The webs 33 on the rear side 88 of the carrier plate 8 have a height of approximately 0.3 mm to approximately 2 mm, so that the lighting device 102 can be significantly stiffened by the webs 33 and thus mechanical strength against bending and twisting can be achieved, which could otherwise result in cracks of the connecting layer 6, semiconductor chips 1, and the metallically conductive layer 4.

In addition to the power supply, the metallically conductive layer 4 is also used, as described in the general part, for the heat distribution of the waste heat generated in the semiconductor chips 1 in operation, which can be transferred effectively and in a large area to the carrier plate 8 via the metallically conductive layer 4. For improved emission of the heat via the rear side 88 of the carrier plate 8 to the surroundings, a surface coating 34 is applied thereon, for example, in the form of a radiator paint, which has a high degree of thermal emission of as close as possible to 1 in a temperature range from 50° C. to 100° C., for example, preferably at approximately 80° C. Such a temperature can correspond to the typical operating temperature of the lighting device 102.

The emission plate 20 has, as can be clearly seen in FIG. 3, recesses 22 in the form of spherical caps, which are spherical or ellipsoidal and which are preferably embossed or cast. The recesses 22 furthermore have a diameter which corresponds to at least twice the side length of the respective semiconductor chips 1 arranged in a recess 22. The layer made of the wavelength conversion material 21, which is arranged on the inner surface 28 of the recess 22, can thus be arranged thermally separated from the respective semiconductor chip 1, whereby the advantages described above in the general part can be achieved.

Alternatively to the exemplary embodiment shown having the wavelength conversion material 21 on the inner surface 28 of the recesses 22, it can also be possible to apply a wavelength conversion material directly to the semiconductor chips 1 and to provide the inner surfaces 28 of the recesses 22 with a further wavelength conversion material 21 and/or a diffuser material.

Furthermore, the emission plate 20 has scattering particles 25 and also scattering structures 23 and 24 on the light emission surface 29 and the surface facing away from the light emission surface 29, by means of which the emission plate 20 has a diffusively sheer and therefore translucent effect. Furthermore, the emission plate 20 has embedded scattering particles. An improvement of the homogeneity of the emitted brightness and the emitted color impression can be achieved by the scattering structures 23, 24 and the scattering particles 25. Furthermore, the lighting device 102 can be perceived by an observer from the side of the light emission surface 29 without annoying dazzling effects. The scattering structures 23 and 24 can be implemented by embossing or by casting. Alternatively to the exemplary embodiment shown, only scattering particles 25 or only scattering structures 23 and/or 24 can also be provided.

FIG. 4 shows a further exemplary embodiment of a lighting device 103, which, in comparison to the lighting device 102 of the previous exemplary embodiment, has a carrier plate 8 having an insulating plastic layer 41, on which the metallically conductive layer 4 as the reflective mounting surface 89 and, facing away therefrom, a metal plate or metal foil 22 are arranged. The metal plate or metal foil 42 and the insulating plastic layer 41 can be glued to one another, for example. The metal plate or metal foil 42 is connected to a protective ground conductor 43, for example, in accordance with the applicable electrical installation regulations. A shield against possibly existing electrical alternating fields of the power network can thus additionally also be achieved.

The metal plate or metal layer 42 furthermore has, on the side forming the rear side 88 of the carrier plate 8, a lacquer or anodized layer or another coating 34, which, in particular in the event of slightly elevated room temperature, has a particularly high heat power emission coefficient in a wavelength range of approximately 10 μm. This can be achieved by a glazing or an anodization or also by a radiator paint, which can also be made colored and not black, for example.

If the semiconductor chips 1 are fastened by soldering on the metallically conductive layer 4 and connected thereto, for example, by means of a tin-indium solder, the insulating plastic layer 41 is implemented as correspondingly resistant for a few seconds to the short-term heating during the soldering. Alternatively, gluing by means of a heat-conductive and current-conductive adhesive is also possible, which can also be glued with thermal assistance.

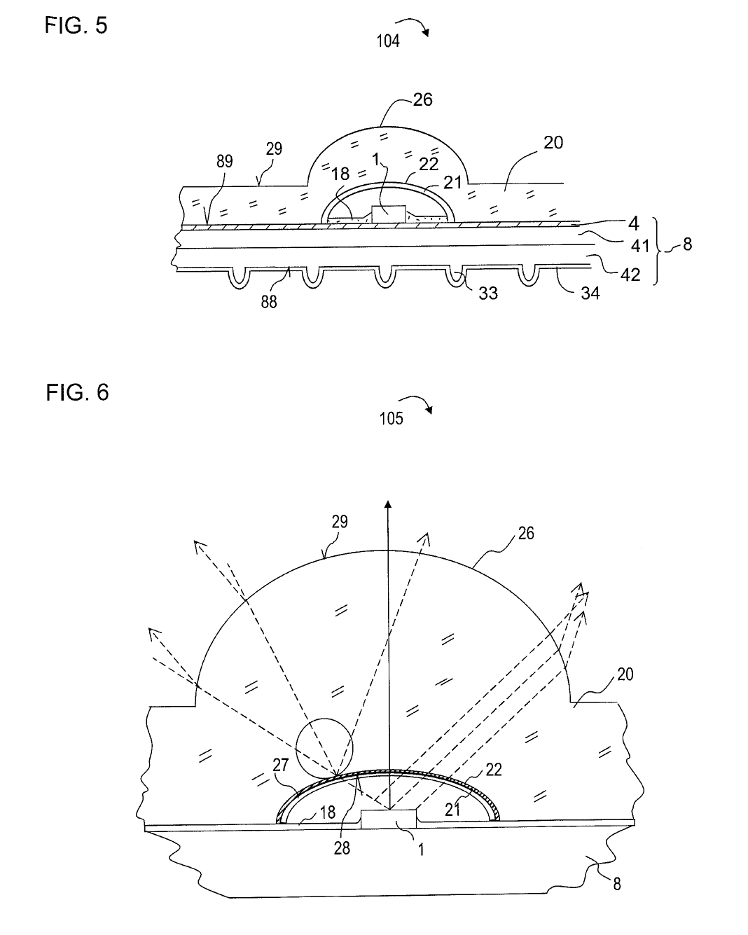

FIG. 5 shows a further exemplary embodiment of a lighting device 104, in which, in comparison to the previous exemplary embodiment, the metal plate 42, which forms the rear side of the carrier plate 8, has webs 33 to improve the mechanical strength and stiffness and also to improve the heat dissipation.

The emission plate 20 of the lighting device 104 furthermore has lens-shaped surface structures 26 over the recesses 22. In the exemplary embodiment shown, the lens-shaped surface structure 26 is implemented as a convex protrusion. Alternatively thereto, in the case of corresponding thickness of the emission plate 20, the lens-shaped surface structure 26 can also be implemented as a concave indentation, for example. Preferably, the bulges 22 and the respective lens-shaped surface structure 26 arranged above them are arranged centered to one another. Furthermore, the semiconductor chips 1 are preferably also arranged in the recesses 22 centered thereto.

The lens-shaped surface structures 26 can be implemented, for example, during the production of the emission plate 20 by corresponding casting or embossing. Furthermore, it is also possible to shape the lens-shaped surface structures 26 later by way of a corresponding method, for example, a rolling method, using a material identical or different in comparison to the emission plate 20. Even if the recesses 22 and the lens-shaped surface structures 26 are shown to be spherical in the exemplary embodiment shown, they can also be aspherical in shape to optimize identical color emission in all emission directions, for example.

FIG. 6 shows a further exemplary embodiment of a lighting device 105, which has lens-shaped surface structures 26 on the light emission surface 29. By means of the dashed lines, the beam paths of the primary light directly emitted from the semiconductor chips 1 and also of the secondary light generated by the wavelength conversion material 21 in the recess 22 are shown in FIG. 6.

The primary light is bundled by the lens-shaped surface structure, while the secondary light, which is emitted from the wavelength conversion material 21 nearly with a Lambert radiation distribution, is also bundled, but with a different emission characteristic than the directly emitted primary light. By way of a suitable arrangement of the semiconductor chips on the carrier plate 8 and also by additional scattering measures such as scattering particles, a scattering coating, or scattering structures, for example, the light emission surface 29 can permit individual light spots having the primary light to be recognized, while a homogeneous superposition of the primary light and the secondary light is perceived at a location to be lighted.

To improve the emission of the secondary light emitted from the wavelength conversion material 21, a reflector layer 27 is arranged on the side of the wavelength conversion material 21 facing toward the semiconductor chip 1, which is transmissive for the primary light generated by the semiconductor chip 1 and which is reflective for the secondary light generated by the wavelength conversion material 21. The reflector layer 27 can be implemented in the form of a Bragg filter, for example.

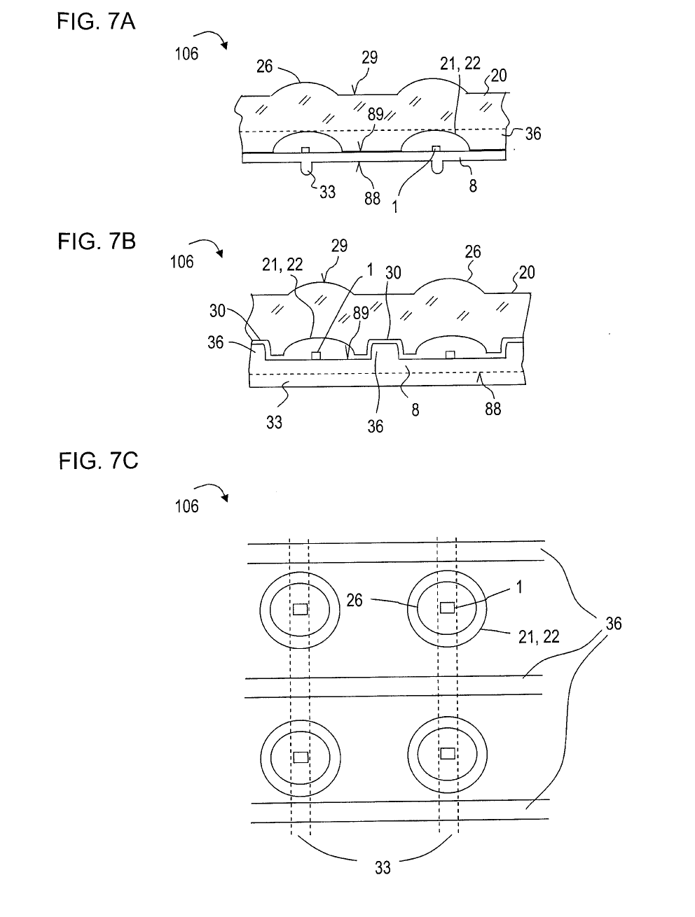

FIGS. 7A to 7C show a further exemplary embodiment of a lighting device 106. The schematic sectional views of FIGS. 7A and 7B extend along the webs 36 or 33, respectively, according to the top view in FIG. 7C. The elements not shown in the respective image plane are respectively indicated in FIGS. 7A and 7B by means of the dashed lines.

The lighting device 106 shown has webs 33 and 36, which extend perpendicularly to one another, both on the reflective mounting surface 89 and also on the rear side 88 opposite thereto. A further improvement and increase of the stiffness or mechanical strength of the lighting device 106 in comparison to the preceding exemplary embodiments can thus be achieved. The emission plate 20 has grooves 30, in which the webs 36 implemented on the reflective mounting surface 89 are arranged.

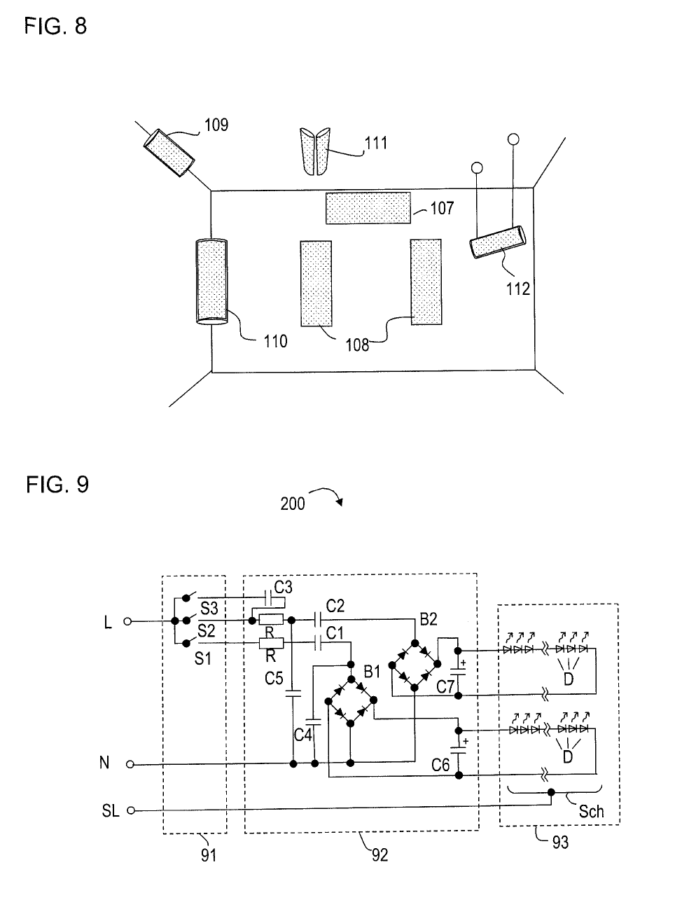

FIG. 8 shows exemplary embodiments for the arrangement of lighting devices in a room. The lighting devices 107 to 112 shown in FIG. 8 can be embodied according to one or more of the preceding exemplary embodiments, for example.

The lighting devices 107 and 108 are arranged horizontally and vertically on or in the wall of the room shown as an example. In the case of an arrangement on the wall, the lighting devices are preferably attached in front of the wall such that rear ventilation is possible, while in the case of an arrangement in the wall, heat dissipation can occur through the wall.

The lighting devices 109 and 110 are arranged horizontally and vertically in room area corners, while the lighting devices 111 are arranged symmetrically to one another tilted on the room ceiling. The lighting device 112 is arranged hanging from the room ceiling, for example, horizontally or also tilted to the horizontal, and can be implemented in a flowing wing form, for example.

In accordance with the horizontal or vertical arrangement of the lighting devices 107 to 112, the webs 33 of the carrier body 8 shown in the preceding exemplary embodiments can be aligned along the direction of gravity, to achieve a convection flow for cooling.

FIG. 9 shows an electronic circuit 200, which is suitable for operating the lighting devices of the preceding exemplary embodiments. By means of the electronic circuit 200, the described lighting devices can easily be operated and activated on a 230 V AC network having a phase conductor L, a neutral conductor N, and a protective ground conductor SL, wherein parts of the electronic circuit 200 can be constructed cost-effectively, reliably, and simply as ballast and can have a good effective power factor and high efficiency.

The electronic circuit 200 has circuit parts 91, 92, and 93, wherein the circuit part 93 can be formed by one of the above-described lighting devices 100 to 112.

The circuit part 91, which is implemented as a so-called turning-on box, is used to set the electrical power, using which the lighting device identified as the circuit part 93 is to be operated via the circuit part 92, which is implemented as a ballast.

The switches S1 and S2 of the circuit part 91, which can also be part of a room installation or can also be integrated in the circuit part 92, are respectively used to set half of the power of the lighting device, in that respectively one half of the light-emitting semiconductor chips of the lighting device, which are identified in FIG. 9 with D, can be turned on by each of the switches S1 and S2. By allocating the maximum power into the two electric circuits switchable by means of the switches S1 and S2, security against total failure in the event of a defect in one of the electric circuits can be achieved. The switch S3 is used to set a low power, for example, for a nightlight function.

To activate the lighting device in the circuit part 93 by means of the switches S1 and S2 of the circuit part 1, the lighting device also has two separate electric circuits having multiple semiconductor chips connected in series. For a high power factor (cos φ), the total forward voltage of the semiconductor chip series should be in the order of magnitude of the alternating current effective voltage or slightly less. For example, as is also shown in the exemplary embodiment of FIG. 4, the lighting device is connected in the circuit part 93 to the protective ground conductor SL by means of the protective contact Sch.

The circuit part 92 embodied as the ballast can be embodied separately from the circuit part 93, i.e., the lighting device, in the supply line of the lighting device or alternatively thereto also integrated in the lighting device. The circuit part 92 has, in the exemplary embodiment shown, current-limiting series capacitors C1 and C2, which have a high voltage strength and current pulse strength in the order of magnitude C=Im/(π·f·(Us−Uc)), wherein Im is the mean current which is applied to the semiconductor chips, f is the network frequency, Us is the network apex voltage, and Uc is the total forward voltage of a semiconductor chip series circuit. For example, for a 50 Hz AC network having 230 V effective and a lighting device having an electrical power of 20 W having a semiconductor chip series forward voltage of approximately 200 V, the current Im is calculated to be 20 W/200 V=0.1 A, and the series capacitance is calculated to be approximately 5 μF.

The capacitor C3 in the electric circuit for low power has, to limit the operating current of the semiconductor chips to a desired fraction of the current in the power branches switchable via the switches S1 and S2, a corresponding fraction of the capacitance of the capacitors C1 and C2. To limit the operating current Im′ in the electric circuit for low power to 1/100 of the operating current Im, the capacitance of the capacitor C3 in the exemplary embodiment shown is approximately 50 nF.

The circuit part 92 furthermore has turning-on limiting resistors R, which are in the order of magnitude of approximately 0.03·Ueff²/P having the effective voltage Ueff and a power loss P, which corresponds in the exemplary embodiment shown to a resistance of approximately 80 ohm at a power loss of less than 1.5 W. The capacitors C4 and C5 are in the order of magnitude of approximately 2 nF in the exemplary embodiment shown, while the capacitors C6 and C7 are embodied as electrolyte capacitors having a capacitance of approximately 1 μF to approximately 5 μF. Furthermore, the circuit part 92 has rectifier units B1 and B2, which are implemented as bridge rectifiers for a current of up to 2 A, in order to be load-proof in relation to turning-on pulses.

Alternatively to the exemplary embodiment shown, the electrical circuit 200 can also have only one current branch, for example, the current branch switchable via the switch S1.

The features and modifications contained in the individual exemplary embodiments shown can also respectively be provided individually or in other combinations in lighting devices, even if these are not explicitly shown. Furthermore, features according to the embodiments described in the general part can alternatively or additionally be provided in the exemplary embodiments.

The invention is not restricted to the description on the basis of the exemplary embodiments by means thereof. Rather, the invention comprises every novel feature and also every combination of features, which includes in particular every combination of features in the patent claims, even if this feature or this combination itself is not explicitly specified in the patent claims or exemplary embodiments.

1-14. (canceled)

15. A lighting device for room lighting, comprising:
a carrier plate having a reflective mounting surface;
a plurality of light-emitting semiconductor chips arranged on the carrier plate and spaced apart from one another; and
a translucent or transparent emission plate arranged downstream from the light-emitting semiconductor chips in an emission direction;
wherein the emission plate has a light outcoupling surface facing away from the light-emitting semiconductor chips;
wherein the emission plate has a plurality of recesses, which are each arranged downstream from at least one semiconductor chip; and
wherein each of the recesses has, on an inner surface facing toward the semiconductor chips, a diffuser material and/or a wavelength conversion material spaced apart from the light-emitting semiconductor chips.

16. The lighting device according to claim 15, wherein the recesses are in the form of spherical caps.

17. The lighting device according to claim 15, wherein the recesses each have a diameter that is larger than side lengths of the semiconductor chips by a factor greater than or equal to 2 and less than or equal to 20.

18. The lighting device according to claim 15, wherein the emission plate has a lens-shaped surface structure over at least some recesses on the light outcoupling surface.

19. The lighting device according to claim 15, wherein respectively one light-emitting semiconductor chip is arranged in one recess in each case.

20. The lighting device according to claim 15, wherein the reflective mounting surface is formed by a metallically conductive layer.

21. The lighting device according to claim 20, wherein the light-emitting semiconductor chips are electrically connected by the metallically conductive layer.

22. The lighting device according to claim 15, wherein the carrier plate has a plurality of webs on the mounting surface and/or on a rear side opposite to the mounting surface.

23. The lighting device according to claim 22, wherein the emission plate has grooves, in which webs of the carrier plate provided on the installation side are arranged.

24. The lighting device according to claim 15, wherein a rear side, which is opposite to the mounting surface, of the carrier plate is formed by a metal plate or metal foil.

25. The lighting device according to claim 15, wherein a rear side, which is opposite to the mounting surface, of the carrier plate has a heat-emitting coating.

26. The lighting device according to claim 15, wherein the emission plate has, for diffuse scattering, scattering particles distributed in the emission plate and/or scattering structures on a rear side opposite to the light outcoupling surface and/or a translucent coating and/or scattering structures on the light outcoupling surface.

27. The lighting device according to claim 15, wherein the emission plate has, in each of the recesses on the inner surface facing toward the semiconductor chips, a wavelength conversion material, which converts light emitted from the semiconductor chips into converted light, and wherein, on the respective side of the wavelength conversion material facing toward the semiconductor chips, a reflector layer is arranged, which is reflective for the converted light and is transmissive for the light emitted from the semiconductor chips.

28. The lighting device according to claim 15, wherein the emission plate is connected to the carrier plate by clamping nails.
